(19) United States
(12) Patent Application Publication
(10) Pub. No.: US 2002/0172206 A1
(43) Pub. Date: Nov. 21, 2002

(54) Method for providing domain name services for heterogeneous transport networks

(76) Inventors: Dhadesugoor R. Vaman, Frederick, MD (US); Joonbum Byun, Rockville, MD (US); Antonio Ruiz, Poughquaq, NY (US)

Correspondence Address: Bill Baker, Megaxess, Inc., Trevion II, Suite 206, 12800 Middlebrook Road, Germantown, MD, 20874, US

(21) Appl. No.: 09/861,088

(22) Filed: May 18, 2001

(51) Int. Cl. H04L 12/28; H04L 12/56

(52) U.S. Cl. 370/395.52; 370/389

(57) ABSTRACT

A method for providing domain name services of heterogeneous transport networks is provided. Internet Protocol (“IP”) address information, in addition to Domain Name Service (“DNS”) name information is ascertained for a given host. Non-IP information for the host, corresponding to non-IP connections, are also ascertained. The DNS name and at least one IP address, in addition to the non-IP information, are utilized to form a DNS record entry for a DNS database. The DNS record entry, once constructed and recorded into the DNS database, stores both IP and non-IP information about the given host. The DNS database can then be queried by an additional host using only a DNS name, in order to retrieve both IP and non-IP address information. Both the IP and non-IP address information, once resolved and returned to the additional host, can be utilized to effectuate both IP and non-IP connections between hosts. The processes, DNS database, and DNS record entry of the present invention form a DNS methodology that works inter-operably with the present DNS service known in the art, and allows a plurality of hosts to connect with each other using heterogeneous transport addresses and connection methodologies.

### SPECIFICATION

### BACKGROUND OF THE INVENTION

1. Field of the Invention

The present invention relates generally to domain name services for networks. More specifically, the invention relates to a method for providing domain name services for heterogeneous transport networks.

2. Related Art

The Domain Name Service (“DNS”) of the Internet presently provides a naming resolution service that maps the domain name or host name of a given host or network into an Internet Protocol (“IP”) address. Such domain and host names have gained wide acceptance, and have become easy and effective ways of identifying hosts on the Internet.

The DNS methodologies specified in the Internet Engineering Task Force (“IETF”) Requests for Comment 1034, 1035, 2308, 2181, 2065 reply to a DNS request with only one or more IP addresses. These methodologies are designed to serve DNS clients in a homogeneous network, such as the Internet, and assume that all servers and client machines thereof have IP addresses only. If a server or client machine can be identified by a network address other than the IP address, the current DNS methodologies cannot resolve the domain or host name into a non-IP network address.

Accordingly, the current DNS methodology is limited because it maps the domain or host name only into IP addresses. In heterogeneous networks where non-IP multiple transport protocols having unique addressing schemes (i.e., the addressing scheme for Asynchronous Transfer Mode (“ATM”) and Frame Relay devices) are used, it is necessary to map the domain or host name into such unique addresses, while preserving the domain and host name methodologies presently in use. Therefore, the need arises to provide a DNS methodology that works in heterogeneous transport networks, and which is further capable of resolving a given domain or host name into both IP addresses and non-IP addresses.

### OBJECTS AND SUMMARY OF THE INVENTION

It is an object of the present invention to provide Domain Name Services for heterogeneous transport networks.

It is an object of the present invention to provide a Domain Name Service (“DNS”) methodology that resolves domain names into IP addresses.

It is a further object of the present invention to provide a DNS methodology that resolves domain names into non-IP addresses, including Asynchronous Transfer Mode (“ATM”) addresses, Frame Relay addresses, and standard telephone numbers.

It is yet another object of the present invention to provide a DNS server and database that store domain names, IP addresses, and non-IP addresses of a given host.

It is still another object of the present invention to provide a DNS methodology that allows a host machine to connect to another host machine using both IP and non-IP connections based upon IP and non-IP addresses stored in the DNS database.

The present invention relates to a method for providing domain name services for heterogeneous transport networks. The DNS name and IP address of a given host on a network are utilized to construct a DNS record for the host. If additional, non-IP addresses exist for the host, such as ATM addresses, Frame Relay addresses, telephone numbers, or other addresses, such non-IP addresses are ascertained and appended to the DNS record. The DNS record is then written to a DNS database, which may be utilized by a DNS service presently in existence. According to the method of the present invention, a host on a network can query the DNS service for a target host's DNS name, and the target host's DNS name can be resolved into both IP and non-IP addresses. Both the IP and the non-IP addresses can then be utilized to effectuate IP and non-IP connections between the hosts, thereby providing DNS services for hosts existing in heterogeneous transport networks.

### BRIEF DESCRIPTION OF THE DRAWINGS

Other important objects and features of the invention will be apparent from the following Detailed Description of the Invention taken in connection with the accompanying drawings in which:

FIG. 1 is a block diagram showing a sample DNS record according to the present invention.

FIG. 2 is a flowchart showing processes for creating and storing a DNS record having both IP and non-IP addresses for a given host.

FIG. 3 is a flowchart showing processes for resolving a given DNS name into both IP and non-IP addresses.

### DETAILED DESCRIPTION OF THE INVENTION

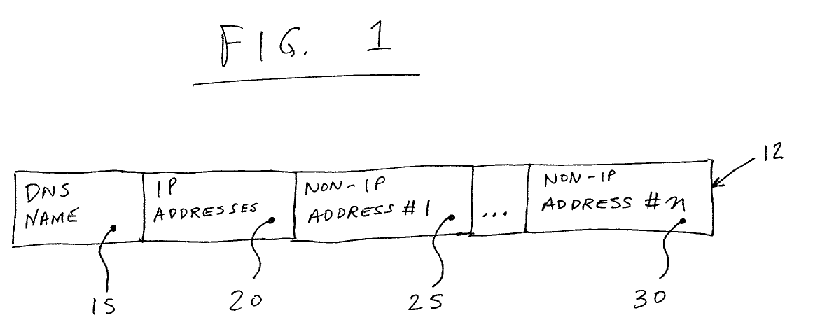

Referring now to the drawings, in which like reference numerals refer to like parts, depicted in FIG. 1 is a sample Domain Name Service (“DNS”) record 12 created by the present invention. DNS record 12 is comprised of at least two components, DNS name field 15 and IP address field 20. DNS name field 15 stores the DNS name of a given host, in a format commonly known in the art (e.g., “www.uspto.gov”). Further, IP address field 20 stores at least one IP address of the given host, also in a format commonly known in the art (e.g., dotted-decimal notation such as 255.255.255.255).

Importantly, DNS record 12 further comprises non-IP address fields 25 through 30, each of which correspond to non-IP addresses for the given host. For example, if two non-IP addresses exist for the given host, such as an Asynchronous Transfer Mode (“ATM”) address and a Frame Relay address, such non-IP addresses could be stored in non-IP address fields 25, 30. It is to be understood that DNS record 12 is not limited to the structure depicted in FIG. 1, and that additional IP and non-IP addresses not depicted may be stored therein. Thus, DNS record 12 has the capability of storing DNS names and IP addresses, in addition to a plurality of non-IP addresses for a given host, thereby allowing a single DNS name to be mapped to a variety of heterogeneous transport addresses, both IP and non-IP.

Importantly, the DNS record structure of the present invention allows a given host to be provided with a plurality of heterogeneous transport addresses in return from a DNS name, thereby allowing the host to use such information to connect with a remote host using a multitude of connection methodologies. For example, if the DNS record of a remote host contains an IP and an ATM address for the remote host, a given host can connect to the remote host using an IP and an ATM connection. This provides the distinct advantage of allowing multiple connection paths to be initiated between two hosts by the provisioning of IP and non-IP address information in response to a simple DNS name query.

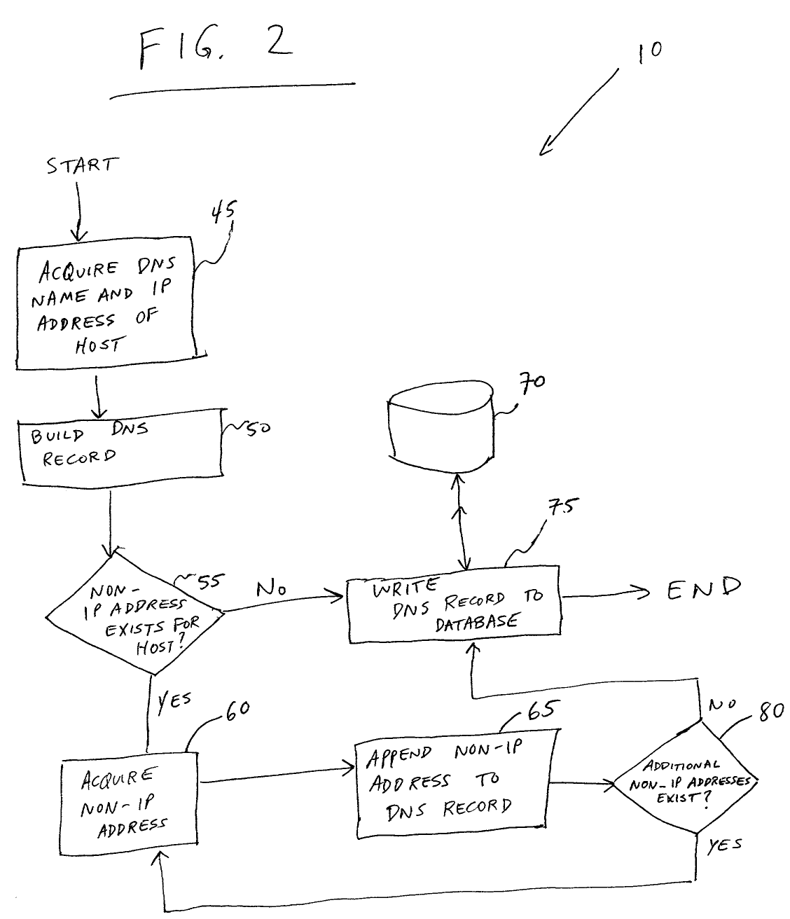

Turning now to FIG. 2, depicted are processes of the present invention 10 for creating and storing a DNS record having both IP and non-IP addresses for a given host. The processes of FIG. 2 are invoked to construct a DNS database in a DNS server using the DNS record structure described previously. Such processes enable the construction of a DNS server that works seamlessly with the present DNS services known in the art, and which provides the further advantage of resolving given DNS names into IP and non-IP addresses.

Beginning in step 45, a DNS name and IP address of a given host is acquired by a DNS server. The DNS name and IP addresses acquired in step 45 are mandatory, so that the DNS record to be created for the host will comply with the present DNS service. Thus, for any given host, at least a DNS name and an IP address for the host will be recorded. Once the DNS name and the IP address of the host are acquired in step 45, step 45 then invokes step 50. In step 50, a DNS record is built for the host, according to the format described above and depicted in FIG. 1. Step 50 constructs a DNS record that contains only the DNS name and at least one IP address for the host. Once the record is created and the DNS name and IP address information are recorded therein, step 50 then invokes step 55.

In step 55, a decision point is reached wherein a determination is made as to whether non-IP addresses exist for the host. Such non-IP addresses include, but are not limited to, ATM addresses, Frame Relay addresses, and telephone numbers. It is to be understood that additional, non-IP addresses are also included. If step 55 determines that no non-IP addresses exist for the host, step 75 is invoked. In step 75, the DNS record is then written to DNS database 70, and execution terminates. Thus, a DNS record containing only IP information will be written to DNS database 70.

In the event that step 55 determines that non-IP addresses exist for the host, step 55 invokes step 60. In step 60, the first non-IP address for the host is acquired. Then, in step 65, the first non-IP address is appended to the DNS record, consistent with the structure described above and depicted in FIG. 1. Once the first non-IP address is appended to the DNS record, step 65 invokes step 80, where another decision point is reached. In step 80, a determination is made as to whether additional non-IP addresses exist for the host. If a positive determination is made, step 80 then re-invokes step 60, so that the next non-IP address can be acquired and later appended to the DNS record. The processing described in steps 60, 65, and 80 continue until all non-IP addresses for the host have been acquired and appended to the DNS record.

If step 80 determines that no additional non-IP addresses exist for the host, step 80 then invokes step 75, described above. In step 75, the DNS record, having both IP and non-IP addresses, is then written to DNS database 70, and processing terminates. Thus, using the processes disclosed in FIG. 2, DNS database 70 can be updated to store a plurality of DNS records, each containing at least a DNS name and an IP address for each host, and optionally, one or more non-IP addresses for the host. DNS database 70 is therefore compliant with the DNS service presently known in the art, and contains additional, non-IP address information.

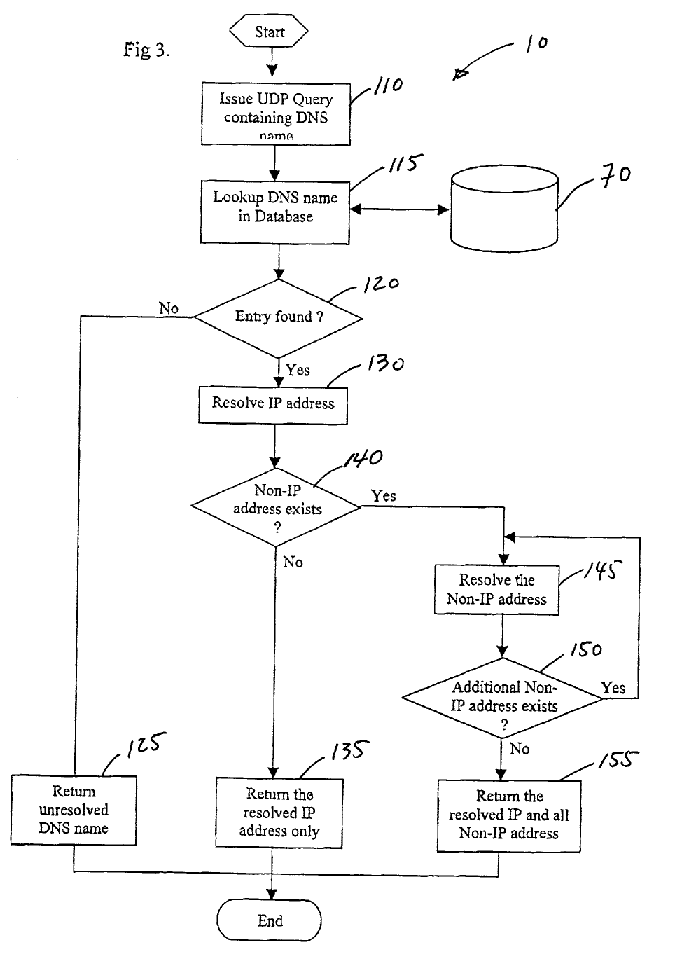

FIG. 3 is a flowchart showing processes for resolving a given DNS name into both IP and non-IP addresses, achieved by the present invention 10. DNS database 70 contains DNS records for a multitude of hosts, each of which may contain both IP and non-IP addresses for the host. This information is useful for a given host that desires to connect to a target host using IP or non-IP connection paths, or both, but which only has available the DNS name of the host. Using the processes described in FIG. 3, the given host can resolve the DNS name into both IP and non-IP addresses, and can use such addresses to effectuate both IP and non-IP connections to the remote host.

Beginning in step 110, the given host receives a User Datagram Protocol (“UDP”) query containing a given DNS name, which may correspond to the DNS name of a target host to which the given host would like to connect. Further, the UDP query issued in step 110 is formatted in accordance with present DNS query formats known in the art, so that compatibility with the DNS methodology already in existence is maintained. Once the UDP query is issued in step 110, it is then received by a DNS server in step 115. According to step 115, the DNS name contained in the UDP query is then looked up in DNS database 70, so that a matching DNS record corresponding to the target host can be found. When step 115 completes the lookup procedure, it then invokes step 120, wherein a decision point is reached. If step 120 determines that no DNS record entry corresponding to the desired DNS name was found in DNS databse 70, step 120 invokes step 125. In step 125, the unresolved DNS name is returned to the given host, thereby indicating that the target host was not found.

In the event that step 120 determines that a DNS record corresponding to the desired DNS name was found, step 120 invokes step 130, wherein the IP address is resolved. The DNS record entry contains at least the DNS name and at least one IP address of the target host, and can optionally include non-IP addresses for the target host, and is generally configured in the record format described above and depicted in FIG. 1. Once the IP address is resolved in step 130, step 140 is invoked, wherein another decision point is reached. In step 140, a determination is made as to whether a non-IP address exists in the DNS record entry. If a positive determination is made, step 140 invokes step 145, wherein the first non-IP address is resolved. In the event that step 140 determines that no IP addresses exist in the DNS record entry, processing terminates and the given host will be provided with only the resolved IP address of the target host, indicating that only an IP connection is available between the given host and the target host at 135.

In the event that step 145 is called by step 140 and the first non-IP address is resolved, step 145 then invokes step 150, where a final decision point is reached. In step 150, a determination is made as to whether additional non-IP addresses exist in the DNS record entry. If a positive determination is made, step 150 re-invokes step 145 so that additional, non-IP addresses can be returned to the user and resolved. Steps 150 and 145 can repeat until all non-IP addresses in the DNS record entry are resolved.

When step 150 determines that additional non-IP addresses do not exist, processing terminates, and the given host will be provided with resolved IP and non-IP addresses, indicating that both IP and non-IP connections are available to the target host at 155. Accordingly, the methodology of FIG. 3 allows the resolution of at least an IP address of the target host, and optionally, non-IP addresses, thereby allowing hosts to connect to each other using heterogeneous transport addresses and connections established therebetween.

For purposes of further description, the DNS resolution processes achieved by the present invention can be represented by the following function, whereby:

F(host)={IP_{—}addr(host),non_{—}IP_{—}addr_{—}1(host), . . . , non_{—}IP addr_{—}n(host)}

### Function 1.

where n=the total number of non-IP addresses for the host. Thus, according to Function 1, a given host name host is first utilized by sub-function IP_addr() to resolve the host name into at least one IP address. Then, the functions non_IP_addr_{—}1 () through non_IP_addr_n () are applied to given host name host, depending upon the total number of non-IP addresses available for the given host name. Thus, a given host name can be resolved to at least one IP address, and optionally, a plurality of non-IP addresses.

Having thus described the invention in detail, it is to be understood that the foregoing description is not intended to limit the spirit and scope thereof. What is desired to be protected by Letters Patent is set forth in the appended claims.

What is claimed is:

1. A method for providing multiple transport protocol addresses for a domain name comprising:
acquiring a DNS name and at least one IP address of a host;
constructing a DNS record for the host;
storing the DNS name and the at least one IP address in the DNS record;
acquiring a non-IP address of the host;
appending the non-IP address to the DNS record; and
storing the DNS record in a DNS database.

2. The method of claim 1 further comprising:
determining if additional non-IP addresses exist for the host;
appending the additional non-IP addresses to the DNS record; and
refreshing the DNS database with the appended DNS record.

3. The method of claim 2, wherein the step of acquiring the non-IP address further comprises acquiring an ATM address of the host.

4. The method of claim 3, wherein the step of appending the non-IP address further comprises appending the ATM address to the DNS record.

5. The method of claim 2, wherein the step of acquiring the non-IP address further comprises acquiring a frame relay address of the host.

6. The method of claim 5, wherein the step of appending the non-IP address further comprises appending the frame relay address to the DNS record.

7. The method of claim 2, wherein the step of acquiring the non-IP address further comprises acquiring a telephone number of the host.

8. The method of claim 7, wherein the step of appending the non-IP address further comprises appending the telephone number to the DNS record.

9. A method for resolving a domain name into multiple transport protocol addresses comprising:
querying a DNS database for a host DNS name;
receiving a DNS record from the DNS database corresponding to the host DNS name;
extracting at least one IP address from the DNS record;
returning the at least one IP address;
extracting a non-IP address from the DNS record; and
returning said non-IP address.

10. The method of claim 9 wherein the step of extracting a non-IP address further comprises extracting an ATM address corresponding to the host DNS name.

11. The method of claim 9 wherein the step of extracting a non-IP address further comprises extracting a frame relay address corresponding to the host DNS name.

12. The method of claim 9 wherein the step of extracting a non-IP address further comprises extracting a telephone number corresponding to the host DNS name.

13. The method of claim 9 further comprising connecting a first host to a second host using the at least one IP address.

14. The method of claim 9 further comprising connecting a first host to a second host using the non-IP address.
